(19) United States
(12) Patent Application Publication
(10) Pub. No.: US 2026/0175271 A1
(43) Pub. Date: Jun. 25, 2026

(54) NOZZLE CLEANING APPARATUS

(71) Applicant: SAMSUNG ELECTRONICS CO., LTD., Suwon-si (KR)

(72) Inventors: Yoodong YANG, Suwon-si (KR); Seungyuel LEE, Suwon-si (KR); Seong-Ho KANG, Suwon-si (KR); Youngho KIM, Suwon-si (KR); Youngho KIM, Suwon-si (KR); Seungjae ROH, Suwon-si (KR); Dong-Hyun LEE, Suwon-si (KR); Jonghyun LEE, Suwon-si (KR)

(73) Assignee: SAMSUNG ELECTRONICS CO., LTD., Suwon-si (KR)

(21) Appl. No.: 19/271,147

(22) Filed: Jul. 16, 2025

(30) Foreign Application Priority Data
Dec. 23, 2024 (KR) 10-2024-0194342

(51) Int. Cl. B08B 9/023

(52) U.S. Cl. CPC B08B 9/023; B08B 2209/02

(57) ABSTRACT

A nozzle cleaning device includes a first module including an insertion path configured for insertion of a nozzle, a second module connected to the first module, the second module including a first end including a cleaning hole configured for insertion of a tip of the, a second end including a through-hole facing the cleaning hole, and a reservoir including a reservoir wall at least partially surrounding the through-hole and extending to a predetermined height, where an inner wall of the second module forms at least one surface of the reservoir, and a third module including a drain hole connected to the second module, and configured to communicate the through-hole with the outside.

### CROSS-REFERENCE TO RELATED APPLICATION

This application is based on and claims priority to Korean Patent Application No. 10-2024-0194342, filed on Dec. 23, 2024, in the Korean Intellectual Property Office, the disclosure of which is incorporated by reference herein in its entirety.

### BACKGROUND

The present disclosure relates to a nozzle cleaning device.

As the integration of semiconductor devices increases, planarization of the resulting semiconductor substrate becomes important, and by using an interlayer insulating film, planarization and insulation between wires can be achieved simultaneously.

In related art, high-density plasma (HDP) oxide films were used as insulating films to simultaneously achieve flatness and insulation between wires

Since the HDP oxide film is formed under a high temperature and high pressure plasma state, it has excellent step coverage characteristics, making it easy to fill the gap between patterns. However, the HDP oxide film contains components that are highly toxic, and there is a problem of causing defects when in contact with an underlying layer composed of a silicon nitride film, or the like.

To solve these problems, boron-phosphor silicate glass (BPSG) with excellent flattening properties are used. However, in the case of BPSG membranes, there is a problem in that impurities such as boron and phosphorus exist inside the membrane, and these impurities diffuse during the thermal process. In the case of spin-on glass (SOG) films, there are advantages of being inexpensive and having excellent interlayer filling characteristics. However, there is a problem that the SOG film completely melts when subjected to a high-temperature process, so it cannot be used in the initial process of semiconductor devices that require high temperatures.

Tonen SilaZene (TOSZ) is a film material used to form insulating films, lower layers, and SOD films of semiconductor devices. Tonen SilaZene (TOSZ) may refer to perhydro polysilazane (PHPS). TOSZ films have an excellent aspect ratio of 10 to 1 in a microscopic space of about 50 nm, and are widely used due to their excellent gap-fill ability.

The above film component is supplied through a nozzle, and after being supplied through the nozzle, a nozzle cleaning process is required to clean the nozzle tip. The purpose is to extend the usage cycle of the nozzle by periodically cleaning the nozzle tip. However, in related art nozzle cleaning processes, film components remain inside the nozzle, causing problems such as scratches in the subsequent chemical mechanical polishing (CMP) process.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more example embodiments provide a nozzle cleaning device that may be capable of increasing the cleaning power for a nozzle tip.

Additional aspects will be set forth in part in the description which follows and, in part, will be apparent from the description, or may be learned by practice of the presented embodiments.

According to an aspect of an example embodiment, a nozzle cleaning device may include a first module including an insertion path configured for insertion of a nozzle, a second module connected to the first module, the second module including a first end including a cleaning hole configured for insertion of a tip of the, a second end including a through-hole facing the cleaning hole, and a reservoir including a reservoir wall at least partially surrounding the through-hole and extending to a predetermined height, where an inner wall of the second module forms at least one surface of the reservoir, and a third module including a drain hole connected to the second module, and configured to communicate the through-hole with the outside.

According to an aspect of an example embodiment, a nozzle cleaning device may include a first module including an insertion path configured for insertion of a nozzle, a first hole configured to provide a primary cleaning fluid, and a first fluid line configured to move the primary cleaning fluid provided through the first hole to the insertion path, a second module connected to the first module, the second module including a first end comprising a cleaning hole configured for insertion of a tip of the nozzle, a second end including a through-hole facing the cleaning hole, a second hole configured to provide a secondary cleaning fluid, and a second fluid line configured to move the secondary cleaning fluid provided through the second hole, a third module including a drain hole connected to the second module, and configured to communicate the through-hole with the outside, and a funnel portion including a first end in the insertion path, and a second end protruding from the cleaning hole and extending beyond the tip of the nozzle when the nozzle is inserted in the insertion path.

According to an aspect of an example embodiment, a nozzle cleaning device may include a first module including an insertion path configured for insertion of a nozzle, a first hole configured to provide a primary cleaning fluid, and a first fluid line configured to move the primary cleaning fluid provided through the first hole to the insertion path, a second module connected to the first module, the second module including a first end including cleaning hole configured for insertion of a tip of the nozzle, a second end including a through-hole facing the cleaning hole, a second hole configured to provide a secondary cleaning fluid, a second fluid line configured to move the secondary cleaning fluid provided through the second hole, and a reservoir configured to accommodate the secondary cleaning fluid from the second fluid line, a third module including a drain hole connected to the second module, and configured to communicate the through-hole with the outside, and a funnel portion including a first end in the insertion path, and a second end protruding from the cleaning hole and extending beyond the tip of the nozzle when the nozzle is inserted in the insertion path.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a diagram illustrating a nozzle cleaning device according to one or more embodiments;

FIG. 2 is a diagram illustrating a reservoir portion in a nozzle cleaning device according to one or more embodiments;

FIG. 3 is a diagram illustrating a nozzle cleaning device according to one or more embodiments;

FIG. 4 is a diagram illustrating a nozzle cleaning device according to one or more embodiments;

FIGS. 5A, 5B, 6, 7 are diagrams illustrating effects according to a nozzle cleaning device made of polyvinylidene fluoride (PVDF);

FIG. 8 is a diagram illustrating a replacement cycle of a nozzle tip cleaned with a related art nozzle cleaning device; and

FIG. 9 is a diagram illustrating a replacement cycle extension effect of a nozzle tip cleaned with a nozzle cleaning device according to one or more embodiments.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

In addition, size and thickness of each constituent element in the drawings are arbitrarily illustrated for better understanding and ease of description, the following embodiments are not limited thereto. In the drawings, the thickness of layers, films, panels, regions, etc., are exaggerated for clarity. In the drawings, the thickness of some layers and regions may be exaggerated for ease of description.

Throughout this specification and the claims that follow, when it is described that an element is “coupled” to another element, it includes not only the case of being “directly coupled” but also “indirectly coupled” with another element therebetween. In addition, unless explicitly described to the contrary, the word “comprise”, and variations such as “comprises” or “comprising”, will be understood to imply the inclusion of stated elements but not the exclusion of any other elements.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

A spin-on glass (SOG) process during the manufacturing process of a semiconductor may refer to a process that replaces the thin film formation process by chemical vapor deposition (CVD) with spin coating.

The SOG equipment may be mainly divided into a spin coater wafer (SCW), which spin coats a polysilazane-based inorganic compound onto a wafer, and a HP unit, which hardens the oxide film at high temperatures. Tonen SilaZene (TOSZ) is a polysilazane-based material and may be one of the materials used for spin coating wafers.

The SCW may have a nozzle for spraying TOSZ onto the wafer, and a nozzle tip made of a hydrogen fluoride series material may be attached to the end of the nozzle.

In the case of the nozzle for spraying a TOSZ solution, the problem of the TOSZ solution gelling inside and outside the nozzle tip often occurs. Therefore, a nozzle cleaning process is required to clean the nozzle tip after the supply is finished. After the spray from the nozzle is finished, the nozzle tip remains inserted into a specific piece of equipment. The nozzle tip may be cleaned with a cleaning fluid inside the above-mentioned specific equipment.

A nozzle cleaning device 10 according to one or more embodiments can be regarded as equipment for cleaning a nozzle tip.

In the nozzle cleaning process using a conventional nozzle cleaning device, there is a problem in that the nozzle tip portion is not cleaned smoothly.

In particular, the problem of gelation of the TOSZ solution occurs inside and outside the tip of the nozzle that sprays the TOSZ solution.

When a process of forming a TOSZ film is performed using the above-described nozzle, there is a problem in which the gelled material attached to the nozzle tip falls off together with the TOSZ solution sprayed from the nozzle. In this case, the above-described substances settle on the wafer surface, causing micro-scratches when performing the subsequent CMP process.

In addition, in the case of conventional nozzle cleaning devices, there was a problem of hardening occurring at the nozzle tip and the part where the nozzle tip is inserted.

The nozzle cleaning device 10 according to one or more embodiments may improve the above problems of related art nozzle cleaning devices.

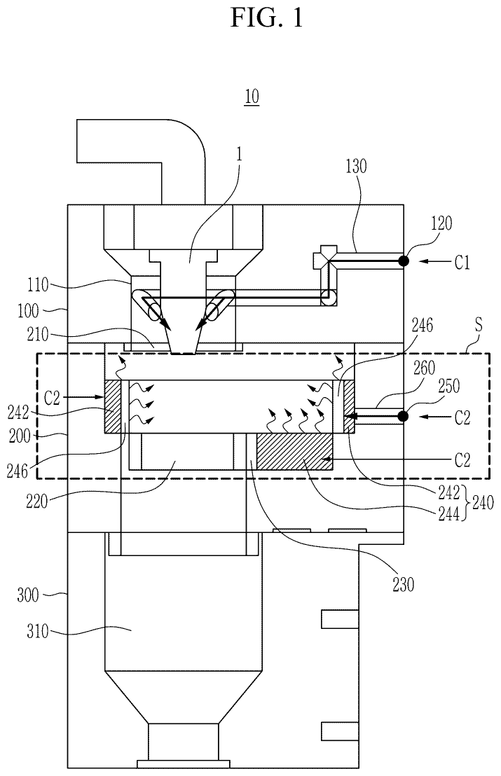

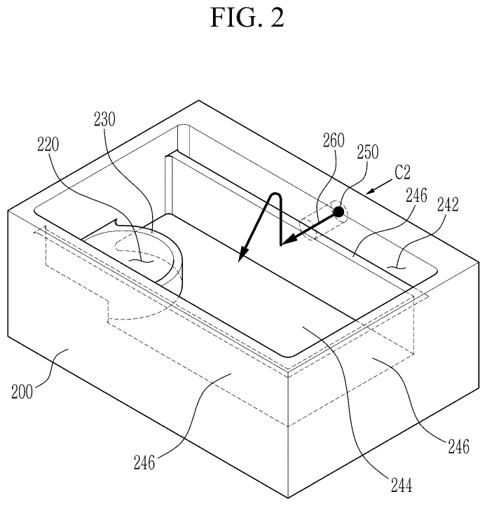

FIG. 1 is a diagram illustrating a nozzle cleaning device according to one or more embodiments. FIG. 2 is a diagram illustrating a reservoir portion in a nozzle cleaning device according to one or more embodiments.

As shown in FIG. 1 and FIG. 2, the nozzle cleaning device 10 according to one or more embodiments may include a first module 100, a second module 200, and a third module 300.

Specifically, the first module 100 including an insertion path 110 into which a nozzle 1 is inserted, the second module 200 connected to the first module 100, having a first end at which a cleaning hole 210 is disposed and into which a tip of the nozzle 1 is inserted, having a second end at which a through-hole 220 is disposed to face the cleaning hole 210, and the third module 300 including a drain hole 310 connected to the second module 200, and configured to communicate the through-hole 220 with the outside may be included.

The first module 100 may include a first hole 120 configured to introduce a primary cleaning fluid C1, and a first fluid line 130 configured to move the primary cleaning fluid C1 introduced through the first hole 120 to the insertion path 110. The primary cleaning fluid C1 may clean the tip of the nozzle 1 disposed in the cleaning hole 210, and then move to the through-hole 220.

The second module 200 may include a second hole 250 configured to introduce a secondary cleaning fluid C2, and a second fluid line 260 configured to move the secondary cleaning fluid C2 introduced through the second hole 250 to a reservoir 240.

Here, the primary cleaning fluid C1 and the secondary cleaning fluid C2 may be the same cleaning fluid, and the cleaning fluid may include a cleaning fluid that is generally used for cleaning the nozzle 1.

The second module 200 may include a reservoir 240 including a reservoir wall 230 having a protruding structure from an inner wall of the second module 200 (e.g., an inner wall of the reservoir 240), at least partially surrounding the through-hole 220 and extending to a predetermined height. In addition, the reservoir 240 may be formed by an inner wall of the second module 200 and the reservoir wall 230. That is, the reservoir 240 may be a structure including side walls correspond to inner walls of the second module 200 as well as the outer wall of the reservoir wall 230.

A first end of the second fluid line 260 may be disposed on an inner wall of the reservoir 240, and a second end thereof may be disposed in the second hole 250. The secondary cleaning fluid C2 introduced through the second hole 250 may move along the second fluid line 260 toward the reservoir 240. That is, the secondary cleaning fluid C2 sprayed from the second fluid line 260 may be accommodated in the reservoir 240.

As shown in FIG. 1, the nozzle cleaning device 10 according to one or more embodiments may increase the amount of the secondary cleaning fluid C2 accommodated in the reservoir 240 by forming a height of the reservoir 240 to be greater than or equal to the predetermined height of the reservoir wall 230.

The reservoir 240 may include a first reservoir portion 242, a second reservoir portion 244. The first reservoir portion 242 and the second reservoir portion 244 may be separated by a barrier wall 246.

The first reservoir portion 242 may be a region of which a first side surface is an inner wall where the first end of the second fluid line 260 is disposed. The second reservoir portion 244 may be a region of which a lower surface is a surface where the through-hole 220 is disposed.

The barrier wall 246 may divide the first reservoir portion 242 and the second reservoir portion 244. Accordingly, the barrier wall 246 may have a structure that forms a side surface of at least one of the first reservoir portion 242 and the second reservoir portion 244.

As shown in FIG. 2, the secondary cleaning fluid C2 may move along the second fluid line 260, and after being provided into the first reservoir portion 242, move beyond (i.e., over) the barrier wall 246 to the second reservoir portion 244. A height of the barrier wall 246 may be higher than a height of the reservoir wall 230 (e.g., the predetermined height).

During the process of moving from the first reservoir portion 242 to the second reservoir portion 244, the secondary cleaning fluid C2 introduced into the second module 200 flows along the barrier wall 246, so that an evaporation surface area of the secondary cleaning fluid C2 inside the second module 200 may be increased.

As such, by increasing the evaporation amount of the secondary cleaning fluid C2, the nozzle cleaning device 10 according to one or more embodiments may prevent drying of the tip of the nozzle 1, and may minimize hardening that may occur at the tip of the nozzle 1 and the insertion path 110.

In the structure of the reservoir 240 according to one or more embodiments, the space within the second module 200 may be regarded as a structure to maintain the vapor-saturated environment by the secondary cleaning fluid C2.

The drain hole 310 of the third module 300 may serve to drain the primary cleaning fluid C1 and the secondary cleaning fluid C2 to the outside.

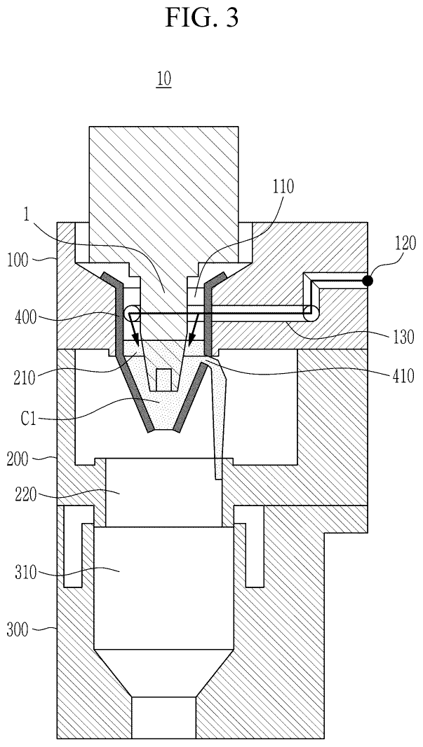

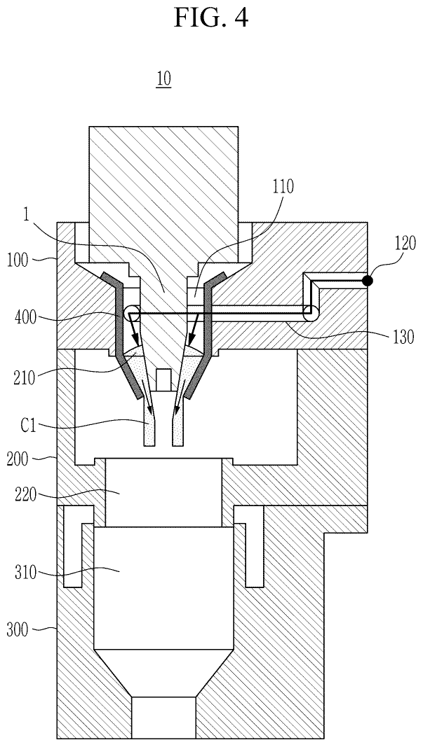

FIG. 3 is a diagram illustrating a nozzle cleaning device according to one or more embodiments. FIG. 4 is a diagram illustrating a nozzle cleaning device according to one or more embodiments.

Referring to FIG. 3 and FIG. 4, the nozzle cleaning device 10 according to one or more embodiments may include the first module 100, the second module 200, the third module 300, and a funnel portion 400.

The first module 100 may include the insertion path 110 into which the nozzle 1 is inserted, the first hole 120 configured to introduce the primary cleaning fluid C1, and the first fluid line 130 configured to move the primary cleaning fluid C1 introduced through the first hole 120 to the insertion path 110.

The second module 200 may be connected to the first module 100, may have a first end at which the cleaning hole 210 is disposed and into which the tip of the nozzle 1 is inserted, may have a second end at which the through-hole 220 is disposed to face the cleaning hole 210, may include the second hole 250 configured to introduce the secondary cleaning fluid C2, and may include the second fluid line 260 configured to move the secondary cleaning fluid C2 introduced through the second hole 250 (see FIG. 1).

The third module 300 may be connected to the second module 200, and may include the drain hole 310 configured to communicate the through-hole 220 with the outside.

The funnel portion 400 may have a structure having a first end disposed in the insertion path 110, and may have a second end disposed to protrude from the cleaning hole 210 and extend beyond the tip of the nozzle 1 when the nozzle 1 is inserted in the insertion path 110.

As shown in FIG. 3 and FIG. 4, the first fluid line 130 may be disposed in the funnel portion 400, and the primary cleaning fluid C1 sprayed from the first fluid line 130 may move along an interior circumference of the funnel portion 400.

The second end of the funnel portion 400 may have a structure that is inclined toward the tip of the nozzle 1. That is, the second end of the funnel portion 400 may have a V-shape extending toward the bottom of the second module 200.

Referring to FIG. 3, the funnel portion 400 may further include a discharge hole 410 disposed at an intermediate height between the cleaning hole 210 and an end point of the tip of the nozzle 1. The discharge hole 410 may outlet the primary cleaning fluid C1, which is provided in the inner circumference of the funnel portion 400, toward the through-hole 220.

That is, the discharge hole 410 may serve to prevent the primary cleaning fluid C1 accommodated in the inner circumference of the funnel portion 400 from being excessively filled.

In FIG. 3, the tip of the nozzle 1 immersed in the funnel portion 400 may be understood to be cleaned by a submerged cleaning method.

In the case of a cleaning method in which the cleaning fluid is sprayed only to an outer side of the tip of the nozzle 1, the cleaning time is short, and cleaning of the inner side of the nozzle tip is not possible, causing the problem in that the solution (TOSZ) may be gelled inside and outside the nozzle tip.

However, since the nozzle cleaning device 10 according to one or more embodiments utilizes the submerged cleaning method, cleaning of the inside and the outside of the tip of the nozzle 1 is achieved.

Specifically, with the nozzle cleaning device 10 according to one or more embodiments shown in FIG. 3, since the tip of the nozzle 1 is immersed in the primary cleaning fluid C1, an inner side of the tip of the nozzle 1 may also be cleaned. In addition, foreign substances attached to the outer side of the tip of the nozzle 1 may be removed while the primary cleaning fluid C1 flows along the interior circumference of the funnel portion 400.

Referring to FIG. 4, a height of the second end of the funnel portion 400 may be disposed close to a height at which the end point of the tip of the nozzle 1 is disposed. Compared to the position of the second end of the funnel portion 400 shown in FIG. 3, a position of the second end of the funnel portion 400 shown in FIG. 4 is disposed closer to the tip of the nozzle 1.

In one or more embodiments, this ensures that the height of the second end of the funnel portion 400 is the same as or slightly extended from the height of the tip of the nozzle 1 (see FIG. 4), so that the primary cleaning fluid C1 escaping from the second end of the funnel portion 400 may flow to wipe a circumference of the tip of the nozzle 1. In other words, the level of the end of the funnel portion 400 may be the same or substantially the same as a level of the tip of the nozzle 1.

Accordingly, the cleaning power of the tip of the nozzle 1 may be increased. Since the fluid line is narrowed around the hole exiting the funnel portion 400 and the flow rate becomes faster, the cleaning power of the tip of the nozzle 1 may be increased due to the fast flow rate.

As described with reference to FIG. 1 to FIG. 4, when the nozzle 1 is cleaned by using the nozzle cleaning device 10 according to one or more embodiments, the amount of the secondary cleaning fluid C2 accommodated in the reservoir 240 may be increased by expanding the height of the reservoir 240 within the second module 200.

In addition, by allowing the secondary cleaning fluid C2 introduced into the second module 200 to flow along the barrier wall 246 while moving to the reservoir 240, the evaporation surface area of the secondary cleaning fluid C2 inside the second module 200 may be increased to increase the evaporation amount, and the hardening phenomenon that may occur at the tip of the nozzle 1 and the insertion path 110 may be minimized.

In addition, as a structure in which the primary cleaning fluid C1 is filled in the funnel portion 400, the tip of the nozzle 1 is maintained to be immersed in the primary cleaning fluid C1, so that cleaning may be performed to the inner side of the tip of the nozzle 1 while minimizing the hardening that may occur at the tip of the nozzle 1. Thus, by adjusting the amount of the primary cleaning fluid C1 filled in the funnel portion 400 through the discharge hole 410, the overflow phenomenon of the primary cleaning fluid C1 may be prevented.

In addition, at a position close to the tip of the nozzle 1, since an end point of the funnel portion 400 extending beyond the tip of the nozzle 1 has a structure inclined toward the tip of the nozzle 1 (e.g., in a cross-sectional view, sides of the funnel portion 400 approach closer to the tip of the nozzle 1 as the funnel portion 400 extends towards the bottom of the second module 200), the primary cleaning fluid C1 exiting the end point of the funnel portion 400 may wipe the circumference of the tip of the nozzle 1 downward, thereby achieving the effect that the cleaning power of the tip of the nozzle 1 may be increased.

According to one or more embodiments, the nozzle cleaning device 10 according to one or more embodiments may include the first module 100, the second module 200 including the reservoir 240, the third module 300, and the funnel portion 400 (see FIG. 1 to FIG. 4).

In addition, in the nozzle cleaning device 10 according to one or more embodiments, at least one of the first module 100, the second module 200, the third module 300, and the funnel portion 400 may include a polyvinylidene fluoride (PVDF) material.

The first module 100 may include the insertion path 110 into which the nozzle 1 is inserted, the first hole 120 configured to introduce the primary cleaning fluid C1, and the first fluid line 130 configured to move the primary cleaning fluid C1 introduced through the first hole 120 to the insertion path 110.

The second module 200 may be connected to the first module 100, may have a first end at which the cleaning hole 210 is disposed and into which the tip of the nozzle 1 is inserted, may have a second end at which the through-hole 220 is disposed to face the cleaning hole 210, may include the second hole 250 configured to introduce the secondary cleaning fluid C2, may include the second fluid line 260 configured to move the secondary cleaning fluid C2 introduced through the second hole 250, and may include the reservoir 240 configured to accommodate the secondary cleaning fluid C2 sprayed from the second fluid line 260.

The second module 200 may include the reservoir wall 230 at least partially surrounding the through-hole 220 and extending to a predetermined height, and the reservoir 240 may be formed of the reservoir wall 230 and at least one inner wall of the second module 200.

The reservoir 240 may include a first reservoir portion 242 having a first side surface that is the inner wall where the first end of the second fluid line 260 is disposed, a second reservoir portion 244 having a lower surface that is a surface where the through-hole 220 is disposed, and a barrier wall 246 configured to divide the first reservoir portion 242 and the second reservoir portion 244.

The barrier wall 246 may include three barrier walls 246 disposed parallel to three inner walls of the second module 200. A side surface of the first reservoir portion 242 may be formed of the inner wall of the second module 200 and the three inner walls (the barrier wall 246) that are connected.

The third module 300 may be connected to the second module 200, and may include the drain hole 310 configured to communicate the through-hole 220 with the outside.

The funnel portion 400 may be disposed to have a first end disposed in the insertion path 110, and have a second end protruding from the cleaning hole 210 and extending beyond the tip of the nozzle 1 when the nozzle 1 is inserted into the insertion path 110.

The funnel portion 400 may further include the discharge hole 410 disposed at an intermediate height between the cleaning hole 210 and the tip of the nozzle 1. The discharge hole 410 may serve to discharge the primary cleaning fluid C1 through the through-hole 220 (see FIG. 3).

The second end of the funnel portion 400 may have a structure that is inclined toward the tip of the nozzle 1. The height of the second end of the funnel portion 400 may be disposed close to a height at which the tip of the nozzle 1 is disposed (see FIG. 4).

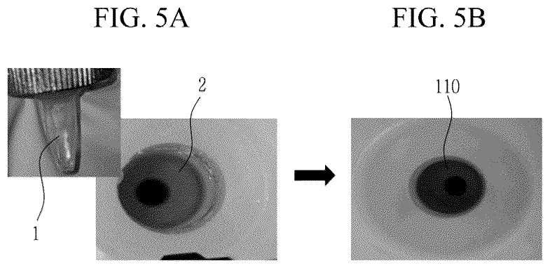

FIGS. 5A, 5B, 6, 7 are diagrams illustrating the effect according to a nozzle cleaning device made of PVDF.

PVDF is a highly unreactive, pure thermoplastic fluoropolymer prepared by the polymerization of vinylidene fluoride. PVDF is a special plastic material belonging to the fluoropolymer series.

PVDF is hydrophilic rather than hydrophobic compared to conventional PTFE (Teflon).

Accordingly, since the fluid flows better on the surface of the PVDF, in the nozzle cleaning device 10 made of PVDF, the teapot effect may be strengthened, especially in the insertion path 110.

The teapot effect refers to the phenomenon in which liquid flows along the spout of a teapot or similar container when pouring. This phenomenon is due to the interaction of inertia and capillary forces, and the smaller the contact angle between the container wall and the liquid surface or the higher the wettability of the material, the better the fluid spreads.

A nozzle cleaning device 10 made of PVDF may have the effect of cleaning the insertion path 110 by flowing the primary cleaning fluid C1 along an interior circumference of the insertion path 110 due to the teapot effect. That is, the primary cleaning fluid C1 sprayed to clean the tip of the nozzle 1 flows along the insertion path 110 and spreads along a wider area, thereby cleaning the insertion path 110 portion.

Compared to the surface energy of the conventionally used PTFE (Teflon) material of 20 mN/m, the surface energy of PVDF is 30.3 mN/m, confirming that the surface energy of PVDF is approximately 1.5 times higher. Accordingly, the interaction with the liquid is reduced, and the fluid spreads more widely over the surface of the PVDF and flows more easily.

FIG. 5A shows an example of contamination of a portion 2 into which a nozzle 1 is inserted in a related art nozzle cleaning device, and FIG. 5B shows the insertion path 110 into which the nozzle 1 is inserted in the nozzle cleaning device 10 according to one or more embodiments (see FIG. 1).

FIG. 5A shows the tip of the nozzle 1 and a peripheral portion 2 into which the tip of the nozzle 1 is inserted inside a conventional nozzle cleaning device. The peripheral portion 2 is contaminated with materials that have fallen from the tip of the nozzle 1 and then accumulated and hardened.

FIG. 5B illustrates the insertion path 110 through which the primary cleaning fluid C1 flows inside the nozzle cleaning device 10 according to one or more embodiments. Unlike FIG. 5A, in FIG. 5B, it may be confirmed that the insertion path 110 is clean without accumulation of the contamination materials (see FIG. 1). This is due to the teapot effect caused by PVDF material, as explained above.

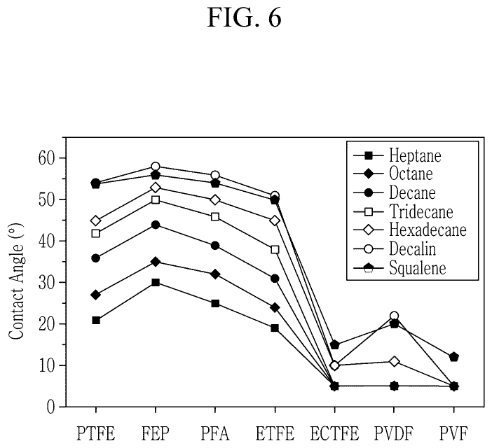

FIG. 6 is a graph showing experimental measurements of wettability for fluorinated resin materials.

It may be understood that the higher the wettability of a material, the better the fluid spreads on the material surface and the smaller the contact angle between the container wall and the liquid surface.

As a result of measuring the contact angle between fluorinated resin materials and nonpolar aprotic liquids having properties similar to the primary cleaning fluid C1 and the secondary cleaning fluid C2 according to one or more embodiments, it may be confirmed that the PTFE (Teflon) material has a higher contact angle than the PVDF material.

That is, the contact angle of the PVDF material is smaller than that of the PTFE (Teflon) material, and this means that the fluid spreads better on the surface of the PVDF material.

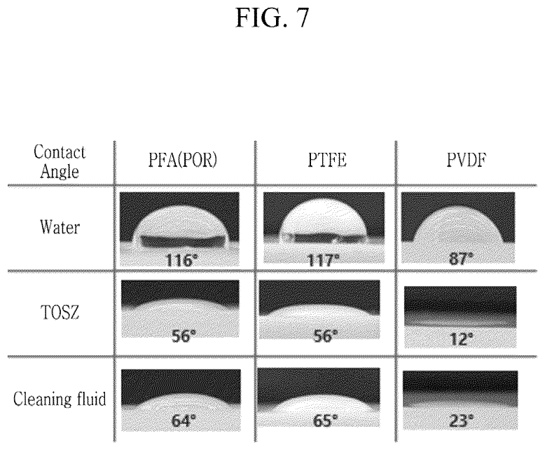

FIG. 7 illustrates a table comparing the contact angles of materials.

Through FIG. 7, it may be confirmed again that the PVDF material has a smaller contact angle than the PTFE (Teflon) material. Specifically, referring to the contact angle result for the cleaning fluid used for cleaning the nozzle, it may be confirmed that the contact angle is 23 degrees for the PVDF material, and 65 degrees for the PTFE (Teflon) material.

In other words, it may mean that the PVDF material has higher wettability and spreads better.

As a result, the nozzle cleaning device 10 according to one or more embodiments is made of the PVDF material, and has an effect that, due to the small contact angle, self-cleaning capability is increased by the teapot effect.

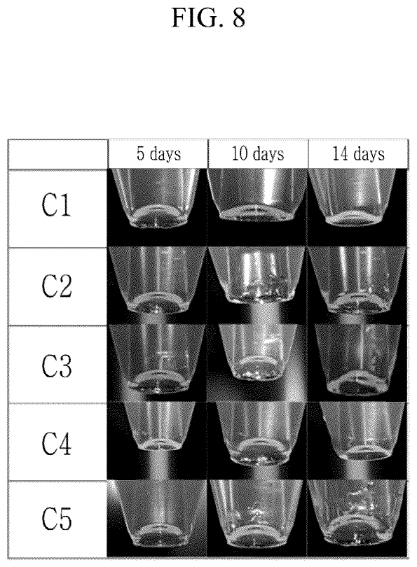

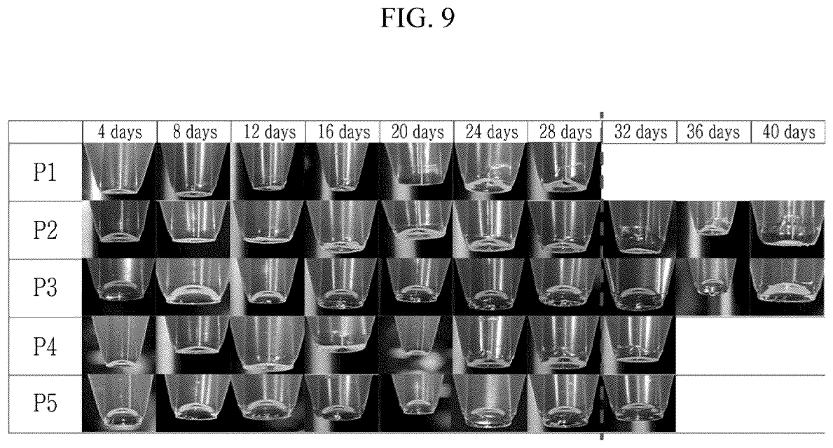

FIG. 8 is a diagram illustrating a replacement cycle of a nozzle tip cleaned with a related art nozzle cleaning device. FIG. 9 is a diagram illustrating a replacement cycle extension effect of a nozzle tip cleaned with a nozzle cleaning device according to one or more embodiments.

Even if the nozzle is cleaned by the nozzle cleaning device, the contamination of the nozzle tip may not be perfectly removed, and therefore, the nozzle tip may be required to be replaced periodically. FIG. 8 and FIG. 9 are data for comparing the replacement cycle of the nozzle tip.

First, referring to FIG. 8, the condition of a nozzle tip cleaned using a related art nozzle cleaning device is shown.

Referring to C1 to C5, each equipped with a different nozzle tip, it may be confirmed that the nozzle tip is damaged at the time point of 10 days of use. Accordingly, it may be seen that the replacement cycle of a nozzle tip cleaned with a conventional nozzle cleaning device is within 10 days.

Referring to P1 to P5 of FIG. 9, each equipped with a different nozzle tip, it may be confirmed that some of the nozzle tips are damaged at the time point of approximately 28 days of use. Accordingly, it may be seen that the replacement cycle of the nozzle tip cleaned using a nozzle cleaning device according to one or more embodiments is approximately 28 days.

As described above, the replacement cycle of the nozzle tip may be extended, thereby providing the advantage of reducing the maintenance cost, and also reducing the engineer's working labor and the time for which engineers are exposed to hazardous substances.

As have been described above, with the nozzle cleaning device 10 according to one or more embodiments, the secondary cleaning fluid C2 introduced into the second module 200 flows along the barrier wall 246 while moving to the reservoir 240, so that by increasing the evaporation amount of the secondary cleaning fluid C2 inside the second module 200, the hardening that may occur at the tip of the nozzle 1 and the insertion path 110 may be minimized.

In addition, in the funnel portion 400, the tip of the nozzle 1 is maintained to be immersed in the primary cleaning fluid C1, so that cleaning may be performed to the inner side of the tip of the nozzle 1 while minimizing the hardening that may occur at the tip of the nozzle 1. In addition, by adjusting the amount of the primary cleaning fluid C1 filled in the funnel portion 400, the phenomenon that the primary cleaning fluid C1 overflows may be prevented, and the primary cleaning fluid C1 exiting the end point of the funnel portion 400 may wipe the circumference of the tip of the nozzle 1 downward, so that the cleaning power of the tip of the nozzle 1 may be increased.

The first module 100 may have a structure that includes no other hole except for the insertion path 110 and the first hole 120. Accordingly, by minimizing the outflow from the interior of the nozzle cleaning device 10 toward the exterior, the internal saturation vapor state of the secondary cleaning fluid C2 may be maintained.

One or more embodiments provide a nozzle cleaning device having a structure in which a nozzle tip penetrates a first module and inserted into a second module disposed below, in which, in an internal structure of the second module, the amount of a cleaning fluid accommodated in a reservoir portion is increased by expanding a height of the reservoir portion.

One or more embodiments provide a nozzle cleaning device in which a cleaning fluid introduced into a second module flows along a wall while moving to a reservoir portion so that the hardening phenomenon that may occur at a nozzle tip and an insertion path into which the nozzle tip is inserted may be minimized by increasing the evaporation surface area of the cleaning fluid inside the second module to increase the evaporation amount.

One or more embodiments provide a nozzle cleaning device having a structure in which a cleaning fluid is filled in a funnel portion surrounding a nozzle tip, in which the nozzle tip is maintained immersed in the cleaning fluid, to minimize hardening occurring at the nozzle tip so that an inner side of the nozzle tip may also be cleaned, and to adjust the amount of the cleaning fluid filled in the funnel portion to prevent the cleaning fluid overflow phenomenon.

One or more embodiments provide a nozzle cleaning device having a structure in which an end point of a funnel portion disposed close to a nozzle tip and extending beyond the nozzle tip is inclined toward the nozzle tip, in which a cleaning fluid flowing along the end point of the funnel portion wipes a circumference of the nozzle tip downward, thereby increasing the cleaning power of the nozzle tip.

According to an embodiment, during the process of cleaning a nozzle, the cleaning power on the nozzle tip may be increased while minimizing hardening that may occur at a nozzle tip.

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. A nozzle cleaning device, comprising:
a first module comprising an insertion path configured for insertion of a nozzle;
a second module connected to the first module, the second module comprising a first end comprising a cleaning hole configured for insertion of a tip of the, a second end comprising a through-hole facing the cleaning hole, and a reservoir comprising a reservoir wall at least partially surrounding the through-hole and extending to a predetermined height, wherein an inner wall of the second module forms at least one surface of the reservoir; and
a third module comprising a drain hole connected to the second module, and configured to communicate the through-hole with the outside.

2. The nozzle cleaning device of claim 1, wherein the first module comprises:
a first hole configured to introduce a primary cleaning fluid; and
a first fluid line configured to move the primary cleaning fluid introduced through the first hole to the insertion path.

3. The nozzle cleaning device of claim 2, wherein the nozzle cleaning device is configured such that the primary cleaning fluid cleans the tip of the nozzle inserted in the cleaning hole, and is then moved to the through-hole.

4. The nozzle cleaning device of claim 1, wherein the second module comprises:
a second hole configured to introduce a secondary cleaning fluid; and
a second fluid line configured to move the secondary cleaning fluid introduced through the second hole to the reservoir.

5. The nozzle cleaning device of claim 4, wherein a first end of the second fluid line is on the inner wall that forms the at least one surface of the reservoir; and
wherein the secondary cleaning fluid from the second fluid line is accommodated in the reservoir.

6. The nozzle cleaning device of claim 4, wherein the reservoir comprises:
a first reservoir portion comprising a first side surface that is the inner wall on which the first end of the second fluid line is disposed;
a second reservoir portion comprising a lower surface on which the through-hole is disposed; and
a barrier wall configured to divide the first reservoir portion and the second reservoir portion.

7. The nozzle cleaning device of claim 6, wherein the second module is configured such that the secondary cleaning fluid flows into the first reservoir portion, and then moves pass the barrier wall to the second reservoir portion.

8. The nozzle cleaning device of claim 7, wherein a height of the barrier wall is greater than the predetermined height of the reservoir wall.

9. The nozzle cleaning device of claim 1, wherein the drain hole is configured to drain a primary cleaning fluid and a secondary cleaning fluid to the outside.

10. A nozzle cleaning device, comprising:
a first module comprising an insertion path configured for insertion of a nozzle, a first hole configured to provide a primary cleaning fluid, and a first fluid line configured to move the primary cleaning fluid provided through the first hole to the insertion path;
a second module connected to the first module, the second module comprising a first end comprising a cleaning hole configured for insertion of a tip of the nozzle, a second end comprising a through-hole facing the cleaning hole, a second hole configured to provide a secondary cleaning fluid, and a second fluid line configured to move the secondary cleaning fluid provided through the second hole;
a third module comprising a drain hole connected to the second module, and configured to communicate the through-hole with the outside; and
a funnel portion comprising a first end in the insertion path, and a second end protruding from the cleaning hole and extending beyond the tip of the nozzle when the nozzle is inserted in the insertion path.

11. The nozzle cleaning device of claim 10, wherein the first fluid line is in the funnel portion such that the primary cleaning fluid provided from the first fluid line moves along an inner circumference of the funnel portion.

12. The nozzle cleaning device of claim 11, wherein the funnel portion further comprises a discharge hole between the cleaning hole and an end point of the tip of the nozzle when the nozzle is inserted in the insertion path; and
wherein the discharge hole outlets the primary cleaning fluid toward the through-hole.

13. The nozzle cleaning device of claim 11, wherein a second end of the funnel portion is inclined toward the tip of the nozzle when the nozzle is inserted in the insertion path.

14. The nozzle cleaning device of claim 11, wherein the drain hole is configured to drain the primary cleaning fluid and the secondary cleaning fluid to the outside.

15. A nozzle cleaning device, comprising:
a first module comprising an insertion path configured for insertion of a nozzle, a first hole configured to provide a primary cleaning fluid, and a first fluid line configured to move the primary cleaning fluid provided through the first hole to the insertion path,
a second module connected to the first module, the second module comprising a first end comprising cleaning hole configured for insertion of a tip of the nozzle, a second end comprising a through-hole facing the cleaning hole, a second hole configured to provide a secondary cleaning fluid, a second fluid line configured to move the secondary cleaning fluid provided through the second hole, and a reservoir configured to accommodate the secondary cleaning fluid from the second fluid line;
a third module comprising a drain hole connected to the second module, and configured to communicate the through-hole with the outside; and
a funnel portion comprising a first end in the insertion path, and a second end protruding from the cleaning hole and extending beyond the tip of the nozzle when the nozzle is inserted in the insertion path.

16. The nozzle cleaning device of claim 15, wherein the reservoir comprises a reservoir wall at least partially surrounding the through-hole and extending to a predetermined height; and
wherein an inner wall of the second module forms at least one surface of the reservoir.

17. The nozzle cleaning device of claim 15, wherein the reservoir comprises:
a first reservoir portion comprising a first side surface that is an inner wall on which a first end of the second fluid line is disposed;
a second reservoir portion comprising a lower surface on which the through-hole is disposed; and
at least one barrier wall configured to divide the first reservoir portion and the second reservoir portion.

18. The nozzle cleaning device of claim 15, wherein the funnel portion further comprises a discharge hole between the cleaning hole and an end point of the tip of the nozzle when the nozzle is when the nozzle is inserted in the insertion path.

19. The nozzle cleaning device of claim 18, wherein the discharge hole is configured to outlet the primary cleaning fluid toward the through-hole.

20. The nozzle cleaning device of claim 15, wherein a second end of the funnel portion is inclined toward the tip of the nozzle when the nozzle is inserted in the insertion path.
